(19) United States
(12) Patent Application Publication
(10) Pub. No.: US 2011/0122268 A1
(43) Pub. Date: May 26, 2011

(54) IMAGING DEVICE

(76) Inventors: Akihiro Okamoto, Osaka (JP); Tetsuji Uno, Shiga (JP)

(21) Appl. No.: 13/002,784

(22) PCT Filed: Jul. 10, 2009
(86) PCT No.: PCT/JP2009/003244

§ 371 Date: Jan. 6, 2011

(30) Foreign Application Priority Data
Jul. 10, 2008 (JP) 2008-179832

(51) Int. Cl. H04N 5/228

(52) U.S. Cl. 348/208.12; 348/E05.031

(57) ABSTRACT

An image capture device that can cut down power dissipation to a certain degree while carrying out an image stabilizing operation to a certain degree at any zoom power is provided.

An image capture device that can change zoom powers includes: an optical system for producing a subject's image; an imager for capturing the subject's image that has been produced by the optical system; a compensation section for stabilizing the subject's image on the imager; and a control section for choosing one of multiple control modes according to the zoom power and controlling the compensation section in the control mode chosen. At least one of the control modes is defined so that the control section instructs the compensation section to stabilize the subject's image during a still picture shooting period and not to stabilize the subject's image during a non-shooting interval other than the still picture shooting period.

### TECHNICAL FIELD

The present invention relates to an image capture device and more particularly relates to an image capture device with an optical image stabilizer (OIS) function.

### BACKGROUND ART

Recently, cameras with the OIS function have become increasingly popular.

For example, Patent Document No. 1 discloses a digital camera with the OIS function. Specifically, if the zoom power specified is greater than a reference power, that digital camera turns the OIS function ON. On the other hand, if the zoom power specified is smaller than the reference power, the digital camera turns the OIS function OFF. In this manner, by turning OFF the image stabilizing operation automatically at such a zoom power that is too low to make the camera shake easily sensible, it is possible to prevent the image from getting blurred unnaturally due to the image stabilizing operation. If the zoom power specified is too high to avoid the shake, however, the image stabilizing operation is performed, thereby canceling the shakiness of the image caused by the camera shake. As a result, the image stabilizing operation can be carried out selectively according to the zoom power specified without getting the image shaken unnecessarily.

### CITATION LIST

### Patent Literature

Patent Document No. 1: Japanese Patent Application Laid-Open Publication No. 2005-195656

### SUMMARY OF INVENTION

### Technical Problem

If the zoom power specified is smaller than the reference power, however, the digital camera disclosed in Patent Document No. 1 turns the OIS function OFF entirely. That is why in such a situation, the digital camera makes no compensation at all for its shake caused by the user's hand or body tremors.

Nevertheless, even if the zoom power specified is usually too low to make the shake easily sensible, the camera shake still needs to be compensated for in some situations, which is not unthinkable at all. But unless the camera shake is compensated for in such a situation, a blurry image of the subject will be shot. In that case, such a shooting error could mean an irreparable loss for some users.

It is therefore an object of the present invention to provide an image capture device that can shoot a great looking image while always carrying out the image stabilizing operation to a certain degree at any zoom power.

### Solution to Problem

An image capture device according to the present invention can change zoom powers. The device includes: an optical system for producing a subject's image; an imager for capturing the subject's image that has been produced by the optical system; a compensation section for stabilizing the subject's image on the imager; and a control section for choosing one of multiple control modes according to the zoom power and controlling the compensation section in the control mode chosen. At least one of the multiple control modes is defined so that the control section instructs the compensation section to stabilize the subject's image during a still picture shooting period and not to stabilize the subject's image during a non-shooting interval other than the still picture shooting period.

The image capture device may further include: a zoom lens for changing the zoom powers by moving along an optical axis; a lens driving section for driving the zoom lens; and a detecting section for detecting the position of the zoom lens. The control section may choose one of the multiple control modes based on a result of detection obtained by the detecting section.

The multiple control modes may include: a first control mode in which the control section instructs the compensation section to stabilize the subject's image continuously, no matter whether it is the still picture shooting period or not; and a second control mode in which the control section instructs the compensation section to stabilize the subject's image during the still picture shooting period but not to stabilize the subject's image during the non-shooting interval. If a range in which the zoom lens is drivable is split into a range including a telephoto end and a range including a wide-angle end, then the control section may choose the second control mode when the zoom lens falls within the range including the wide-angle end and may choose the first control mode when the zoom lens falls within the range including the telephoto end.

The optical system may include a stabilizer lens that is movable within a plane that intersects with the optical axis at right angles. By driving the stabilizer lens of the optical system within the plane, the compensation section may stabilize the subject's image on the imager. The control section may instruct the compensation section to move the stabilizer lens to a predetermined reference position within the plane once the zoom lens has moved from the range including the telephoto end to the range including the wide-angle end.

The control section may instruct the compensation section to move the stabilizer lens to the center of the plane as the reference position.

The image capture device may further include an interface section that allows the user to change the zoom powers. The lens driving section may drive the zoom lens adaptively to the zoom power that has been specified with the interface section. The control section may instruct the compensation section to limit the range in which the stabilizer lens is movable while the zoom lens is being driven.

The image capture device may further include: an interface section that allows the user to change the zoom powers; and an image processing section for magnifying a portion of image data, which has been generated based on the output of the imager so as to represent the subject's image, according to the zoom power that has been specified with the interface section. The control section may choose one of the multiple control modes according to the zoom power that has been specified with the interface section.

### ADVANTAGEOUS EFFECTS OF INVENTION

According to the present invention, one of multiple control modes is defined so that the control section generates an instruction value to reduce the blur of the subject's image that has been caused due to the device's own shake during a still picture shooting period, but generates no instruction value to reduce the blur of the subject's image during a non-shooting interval other than the still picture shooting period. Thus, the present invention provides an image capture device that can shoot a great looking image while always performing the image stabilizing operation to a certain degree irrespective of the zoom power.

### BRIEF DESCRIPTION OF DRAWINGS

FIG. 1 is a block diagram illustrating a configuration for a digital camera 100.

FIG. 2 is a rear view of the digital camera 100.

FIG. 3 shows how the exposure status of a CCD image sensor 180 changes in accordance with a lens position instruction value given by a controller 210 to an OIS actuator 150 in a situation where the mode of operation of the digital camera 100 is MODE 1.

FIG. 4 shows how the exposure status of the CCD image sensor 180 changes in accordance with the lens position instruction value given by the controller 210 to the OIS actuator 150 in a situation where the mode of operation of the digital camera 100 is MODE 2.

FIG. 5 is a flowchart showing an exemplary operation of the digital camera 100 according to a first embodiment of the present invention.

FIG. 6 is a flowchart showing how to perform a control in the image stabilization mode in such a situation where the zoom powers have been changed.

FIG. 7(a) illustrates the maximum range in which a stabilizer lens is movable in a situation where a zoom lever 260 is not turned and FIG. 7(b) illustrates a range in which the stabilizer lens is movable in a situation where the zoom lever 260 is turned.

FIG. 8 is a flowchart showing an exemplary operation of a digital camera 100 according to a second embodiment of the present invention.

### DESCRIPTION OF EMBODIMENTS

### 1. Embodiment 1

Hereinafter, a first embodiment of the present invention, in which the present invention is applied to a digital still camera (which will be simply referred to herein as a “digital camera”), will be described with reference to the accompanying drawings.

### 1-1. Outline

A digital camera as a first embodiment of the present invention includes an optical image stabilizer (which will be abbreviated herein as “OIS”) and a gyrosensor. The digital camera senses an amplitude of its own shake based on the output of the gyrosensor. And according to the amplitude of its own shake that has been sensed, the digital camera drives the OIS. As a result, the digital camera can shoot an image that is hardly affected by the user's hand or body tremors. Such a function of getting an image shot almost without being affected by the user's hand or body tremors will be referred to herein as an “optical image stabilizing function”.

Therefore, an object of the present invention is to provide an image capture device with an optical image stabilizing function that can shoot a great looking image almost without being affected by user's hand tremors or the camera shake.

### 1-2. Configuration

1-2-1. Electrical Configuration

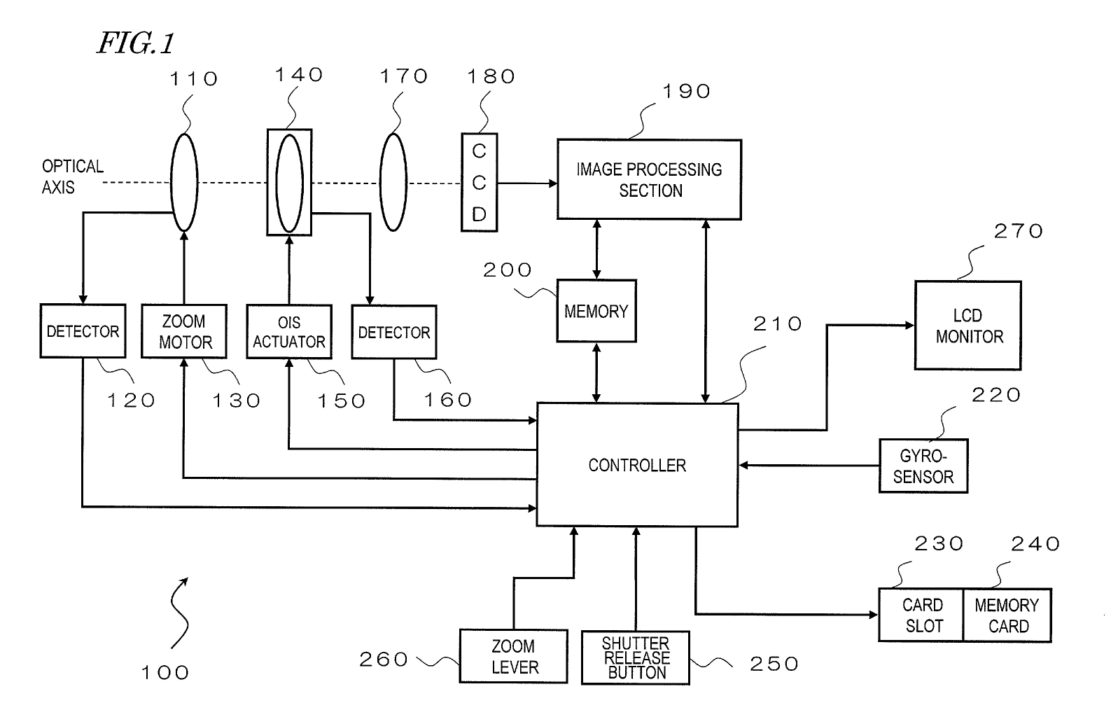

Hereinafter, the electrical configuration of a digital camera as a first embodiment of the present invention will be described with reference to FIG. 1.

FIG. 1 is a block diagram illustrating a configuration for a digital camera 100. This digital camera 100 is designed to make a CCD image sensor 180 capture a subject's image that has been produced by an optical system including a zoom lens 110. The CCD image sensor 180 outputs an electrical signal representing the intensity of light it has received. By subjecting this electrical signal to AD conversion and other kinds of processing, image data representing the subject's image can be obtained. In the following description, however, the CCD image sensor 180 is supposed to generate the image data by itself for convenience sake.

The image data that has been generated by the CCD image sensor 180 is subjected by an image processing section 190 to various kinds of processing and then stored in a memory card 240. If necessary, the image data stored in the memory card 240 can be presented on an LCD monitor 270. Hereinafter, the configuration of this digital camera 100 will be described in further detail.

The optical system of the digital camera 100 is made up of the zoom lens 110, an OIS lens 140, and a focus lens 170. The zoom lens 110 is driven by a zoom motor 130 so as to move along the optical axis of the optical system and thereby zoom in on, or out of, the subject's image. The OIS lens 140 is a stabilizer lens that can move internally within a plane that intersects with the optical axis at right angles. Specifically, the OIS lens 140 is driven by an OIS actuator in such a direction as to cancel the shake of the digital camera 100, thereby stabilizing the subject's image. And the focus lens 170 moves along the optical axis of the optical system, thereby adjusting the focal point on the subject's image.

The zoom motor 130 drives the zoom lens 110. The zoom motor 130 may be implemented as a pulse motor, a DC motor, a linear motor or a servo motor, for example. If necessary, the zoom motor 130 may drive the zoom lens 110 via a cam mechanism, a ball screw, or any other appropriate mechanism. A detector 120 detects the position of the zoom lens 110 on the optical axis. As the zoom lens 110 moves in the optical axis direction, the detector 120 outputs a signal representing the position of the zoom lens through a switch such as a brush. If the zoom motor 130 is a pulse motor, the detector 120 detects only the origin of the zoom lens 110 when this digital camera 100 is turned ON. In that case, once the origin has been detected, a controller 210 senses the position of the zoom lens 110 on the optical axis by counting the number of pulses generated.

An OIS actuator 150 drives the stabilizer lens in the OIS lens 140 within a plane that intersects with the optical axis at right angles. The OIS actuator 150 may be implemented as a planar coil or an ultrasonic motor.

The CCD image sensor 180 captures the subject's image, which has been produced by the optical system including the zoom lens 110, thereby generating image data. The CCD image sensor 180 performs exposure, transfer, electronic shuttering and various other kinds of operations. In this embodiment, an A/D converter (not shown) is built as an integral component in the CCD image sensor 180 to convert an electrical signal in analog form into image data in digital form.

The image processing section 190 subjects the image data that has been generated by the CCD image sensor 180 to various kinds of processing. For example, the image processing section 190 processes the image data that has been generated by the CCD image sensor 180, thereby generating either image data to be presented on the LCD monitor 270 or image data to be stored back into the memory card 240 again. The image processing section 190 may also subjects the image data that has been generated by the CCD image sensor 180 to gamma correction, white balance correction, flaw correction and various other sorts of processing. Furthermore, the image processing section 190 also compresses the image data that has been generated by the CCD image sensor 180 in a compression format compliant with the JPEG standard, for example. The image processing section 190 could be implemented as a DSP or a microcomputer. The image processing section 190 also magnifies a portion of the image data representing the subject's image, which has been generated based on the output of the imager, to a zoom power specified by the user.

The controller 210 performs an overall control on all of these components. The controller 210 may be implemented as a semiconductor device, for example, but could be implemented as either only a single piece of hardware or a combination of hardware and software. For example, the controller 210 could be a microcomputer.

A memory 200 functions as a work memory for the image processing section 190 and the controller 210, and may be implemented as a DRAM or a ferroelectric memory, for example.

The LCD monitor 270 can present an image represented by the image data that has been generated by the CCD image sensor 180 and an image represented by the image data that has been read from the memory card 240.

The gyrosensor 220 may be implemented as a kind of vibrating member such as a piezoelectric transducer. Specifically, the gyrosensor 220 vibrates the vibrating member such as a piezoelectric transducer at a constant frequency and transforms the Coriolis force produced into a voltage, thereby obtaining angular velocity information. Then, the controller 210 gets the angular velocity information from the gyrosensor 220 and outputs an instruction value that instructs the OIS actuator 150 to drive the OIS lens 140 in such a direction that will cancel that shake. As a result, the shake of the digital camera 100 that has been generated by the user's hand or body tremors can be canceled.

The digital camera 100 of this embodiment is supposed to get its own shake, which has been generated by the user's hand or body tremors, sensed by the gyrosensor 220. However, the present invention is in no way limited to that embodiment. Alternatively, a series of two pictures that have been generated sequentially by the CCD image sensor 180 may be compared to each other and if movement has been detected in every pixel in the two pictures, then it may be determined that the camera has been shaken. In that case, the digital camera may also be designed so as to detect, based on the magnitude of movement of the same subject between the two sequentially shot pictures, how much the camera has been shaken.

The memory card 240 can be readily inserted into, or removed from, this digital camera 100 through a card slot 230, which is connectable both mechanically and electrically to the memory card 240. The memory card 240 includes a flash memory or a ferroelectric memory inside, and can store data.

A shutter release button 250 accepts the user's command to shoot a photo, while a zoom lever 260 accepts a zoom power specified by the user.

1-2-2. Rear Arrangement

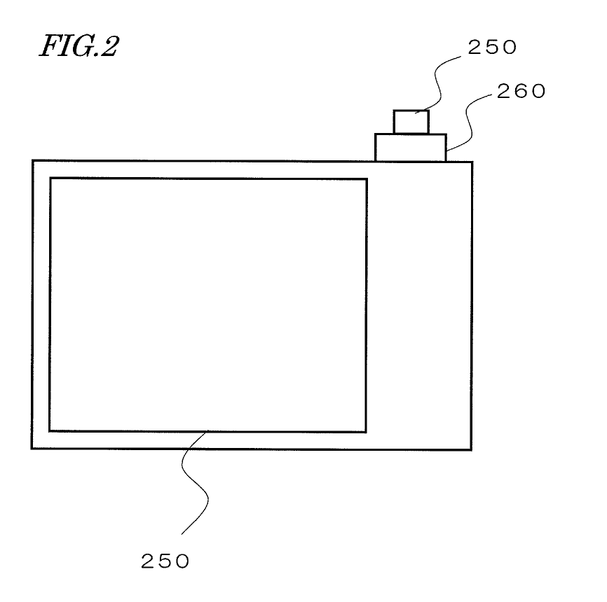

Next, the rear arrangement of the digital camera 100 of this embodiment will be described with reference to FIG. 2.

FIG. 2 is a rear view of the digital camera 100, which includes the shutter release button 250 and the zoom lever 260 at the top surface. The shutter release button 250 is arranged on the top surface of the digital camera 100 so as to be pressed down either halfway or fully. By pressing the shutter release button 250 down halfway, the user can perform an AF control or an AE control. Also, the user can shoot an image by pressing down the shutter release button 250 fully. The zoom lever 260 is arranged around the shutter release button 250 so as to turn either clockwise or counterclockwise. By turning the zoom lever 260, the user can change the zoom powers of the subject's image. For example, if the zoom lever 260 is turned clockwise (to the right), the subject's image will be zoomed in on. On the other hand, if the zoom lever 260 is turned counterclockwise (to the left), the subject's image will be zoomed out of.

### 1-3. Image stabilizing Methods

The digital camera 100 of this embodiment can get the optical image stabilization done by at least two different methods. In other words, the digital camera 100 has at least two different control modes, which will be referred to herein as MODE 1 and MODE 2, respectively, and which will be described in detail below.

It should be noted that although the digital camera 100 is supposed to have at least two different control modes, it is just an example and the camera 100 could also use any number of control modes as long as a control mode corresponding to MODE 2 to be described below is included.

1-3-1. MODE 1

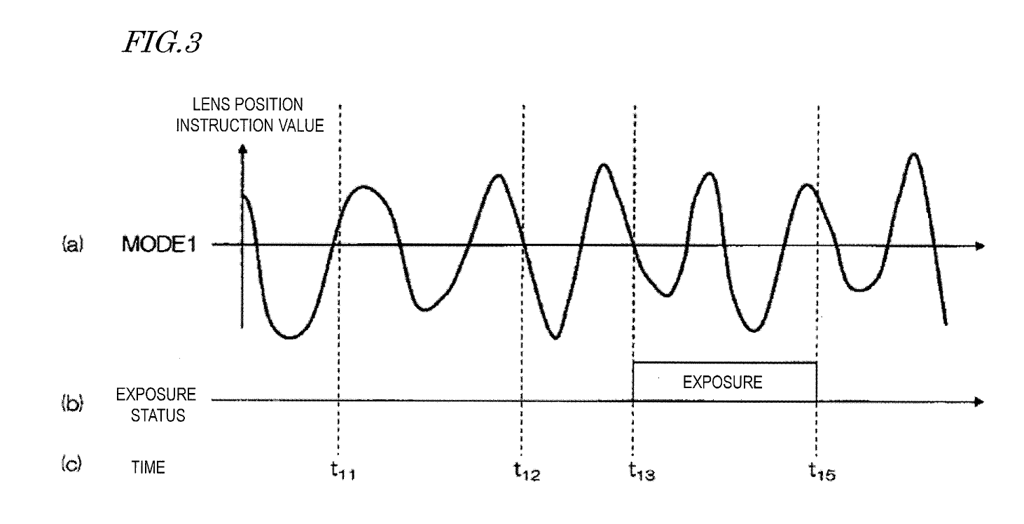

First of all, MODE 1 will be described with reference to FIG. 3.

FIG. 3 shows how the exposure status of the CCD image sensor 180 changes in accordance with a lens position instruction value given by the controller 210 to the OIS actuator 150 in a situation where the mode of operation of the digital camera 100 is MODE 1.

Specifically, portion (a) of FIG. 3 shows how the lens position instruction value given by the controller 210 to the OIS actuator 150 changes with time. Portion (b) of FIG. 3 shows how the exposure status of the CCD image sensor 180 changes with time. And portion (c) of FIG. 3 shows the times at which respective events occur. In this example, the respective events are supposed to occur in the following sequence. Specifically, the shutter release button 250 is pressed down halfway at a time t11 and then fully at a time t13, and the CCD image sensor 180 is subjected to exposure from the time t13 through a time t15. As shown in FIG. 3, the controller 210 gets the operation of stabilizing the image captured performed continuously by the OIS actuator 150 since one still picture shooting session is started and until the next shooting session is started. Such an image stabilization mode will be referred to herein as “MODE 1”.

If the controller 210 controls the OIS actuator 150 in this MODE 1, the image stabilization can get done even when a still picture is not being shot. For example, the image stabilization control can also be performed on a through image that is used as a monitor image for the user to determine the composition of the still picture he or she is going to shoot. In addition, in this MODE 1, the controller 210 can always drive the OIS actuator 150 irrespective of the exposure status of the CCD image sensor 180, and therefore, can get the image stabilization control done relatively easily.

1-3-2. MODE 2

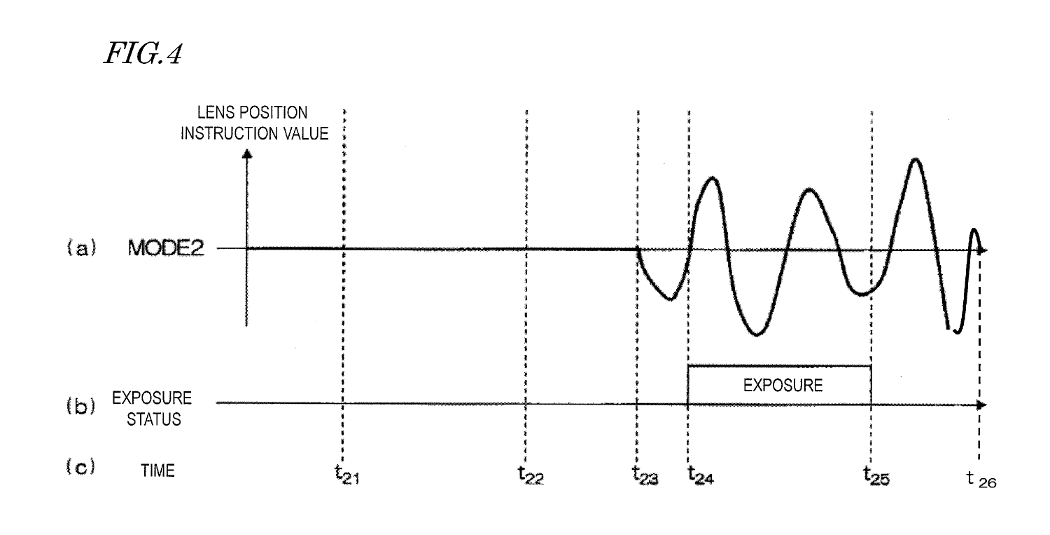

Next, MODE 2 will be described with reference to FIG. 4.

FIG. 4 shows how the exposure status of the CCD image sensor 180 changes in accordance with a lens position instruction value given by the controller 210 to the OIS actuator 150 in a situation where the mode of operation of the digital camera 100 is MODE 2.

Specifically, portion (a) of FIG. 4 shows how the lens position instruction value issued by the controller 210 changes with time. Portion (b) of FIG. 4 shows how the exposure status of the CCD image sensor 180 changes with time. And portion (c) of FIG. 4 shows the times at which respective events occur. In this example, the respective events are supposed to occur in the following sequence. Specifically, the shutter release button 250 is pressed down halfway at a time t21 and then fully at a time t23, and the CCD image sensor 180 is subjected to exposure from a time t24 through a time t25.

As shown in FIG. 4, there is an interval in which the OIS actuator 150 suspends the operation of stabilizing an image captured after one still picture shooting session has been started and before the next still picture shooting session is started. In other words, while the CCD image sensor 180 is generating a through image, there is an interval in which the OIS actuator 150 temporarily stops stabilizing the image captured. As used herein, the “through image” refers to a subject's image that is captured by the CCD image sensor 180 at a time when no still picture is shot. As the through image is presented as a moving picture on the LCD monitor 270, the image can be used to determine the composition of a still picture that the user is going to shoot.

Such an interval in which the operation of stabilizing the image captured is suspended after one still picture shooting session has been started and before the next still picture shooting session is started will be referred to herein as a “non-shooting interval other than a still picture shooting period”.

As used herein, the “still picture shooting period” refers to a period in which a shooting operation is carried out. Strictly speaking, a shooting operation starts when the exposure process is ready to start after the shutter release button 250 has been pressed fully and ends when the exposure process on the CCD image sensor 180 is completed. And a time when the shooting operation is being performed will be referred to herein as “while a still picture is being shot”. A point in time “when the exposure process is ready to start” refers herein to a point in time when the focus control has already been established and when the OIS actuator 150 is driving the OIS lens 140 to get the image stabilization done with stability. In the example shown in FIG. 4, the exposure process is ready to start between the times t23 and t24. On the other hand, the completion of the exposure process corresponds to the time t25 shown in FIG. 4, for example.

It should be noted that as a shooting operation normally gets done in just 0.1 seconds, “the still picture shooting period” is sensed by a human being as just a point in time, not a period with a certain length.

Such an image stabilization mode will be referred to herein as “MODE 2” that includes a still picture shooting period through which the OIS lens 140 is always driven and a through image (moving picture) presentation period through which the OIS lens 140 is not driven.

If the controller 210 drives the OIS actuator 150 in such MODE 2, the stabilizer lens will be driven only when required to shoot a still picture. That is why since the stabilizer lens is not driven in any other situation, the power to be dissipated by the OIS actuator 150 can be cut down.

It should be noted that the optical image stabilization function itself is ON even in the interval between the times t23 and t24 as shown in FIG. 4. This is done in order to carry out the image stabilizing operation with stability through the exposure period by starting the exposure process after the image stabilization function has been turned ON in advance.

Also, in this embodiment, the image stabilization function is not turned OFF right after the exposure period ends but is enabled until a time t26, which is a while after the exposure process has been completed. This is done to carry out the image stabilizing operation with perfect stability at least through the exposure period. That is why it is not until the time t26 that the non-shooting interval other than the still picture shooting period actually begins. For that reason, in this exemplary operation, even though the “stabilizer lens is driven only when required to shoot a still picture”, the image stabilization function is ON not just through the exposure period (from the time t24 through the time t25) but also a pre-exposure period (from the time t23 through the time t24) and a post-exposure period (from the time 25 through the time t26) as well.

But if image stabilization function were turned OFF at, or shortly after, the time t25 when the exposure process is completed, then the shooting operation would also end at that point in time. In that case, if “the stabilizer lens is driven only when required to shoot a still picture”, the image stabilization function would be ON only through the exposure period (from the time t24 through the time t25). And the non-shooting interval other than the still picture shooting period would begin at, or shortly after, the time t25.

In the exemplary MODE 2 described above, other than the core control period (from t23 through t25) for shooting a still picture, including the “non-shooting interval” described above, the lens position instruction value output is maintained at a constant value. However, this is just an example, but any other value may also be output. For example, the lens position instruction value to be output other than the core control period (t23 through t25) for shooting a still picture could be smaller than the instruction value to be output during the control period (from t23 through t25). That is to say, there may be a control mode in which the amplitude of the stabilizer lens driven is decreased. In any case, the controller 210 needs to be able to control the OIS actuator 150 in a number of control modes that should include a mode of operation corresponding to the MODE 2 described above.

### 1-4. Operation

1-4-1. Example of Operation

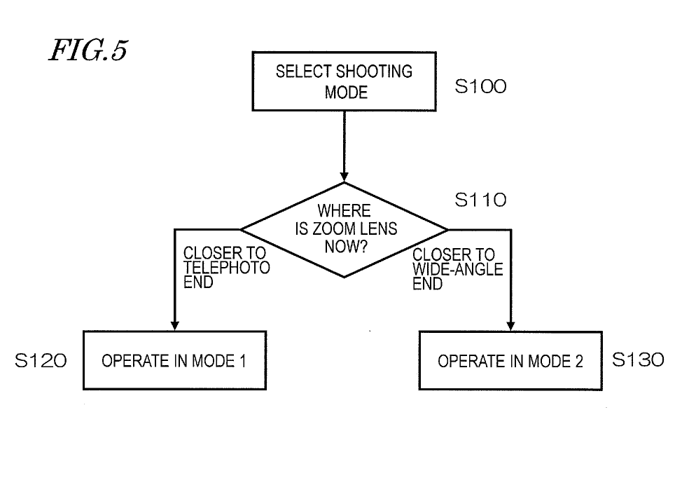

Hereinafter, it will be described with reference to FIG. 5 how this digital camera 100 may work. FIG. 5 is a flowchart showing an exemplary operation of the digital camera 100.

When its mode of operation is set to be a shooting mode in Step S100, the digital camera 100 determines the location of its zoom lens 110 in Step S110. If it has been determined that the zoom lens 110 now falls within a range including a telephoto end, then the controller 210 controls the OIS actuator 150 in MODE 1 in Step S120. On the other hand, if it has been determined that the zoom lens 110 now falls within a range including a wide-angle end, then the controller 210 controls the OIS actuator 150 in MODE 2 in Step S130. In this example, the range in which the zoom lens 110 is movable is supposed to be split at the middle into these two ranges (i.e., the “range including the wide-angle end” and the “range including the telephoto end”). However, it is not always necessary to split the range at the middle. Alternatively, the range in which the zoom lens 110 is movable may also be split at any other arbitrary point into two ranges, one of which is the “range including the wide-angle end” and the other of which is the “range including the telephoto end”.

Next, it will be described why the range in which the zoom lens 110 is movable is split in this embodiment into the “range including the wide-angle end” and the “range including the telephoto end”.

If the zoom lens 110 falls within the range including the telephoto end, the image being captured by the CCD image sensor 180 is easily affected by the camera shake. This is because if the zoom lens 110 falls within the range including the telephoto end, the subject to capture is narrower than a situation where the zoom lens 110 falls within the range including the wide-angle end. In that case, even with a slight camera shake, the subject will move significantly and the composition will change totally. For that reason, if the zoom lens 110 falls within the range including the telephoto end, the controller 210 controls the OIS actuator 150 in MODE 1 in which the OIS lens 140 is always driven even while the through image is generated. As a result, even if the zoom lens 110 falls within the range including the telephoto end, the digital camera 100 can also shoot an image that is hardly affected by the camera shake.

Such a control would be very effective particularly when contrast AF is selected as a mode of autofocusing (AF). As used herein, the “contrast AF” refers to a technique that regards a focal length with the maximum contrast value as representing an in-focus position and is also called “hill-climbing AF”. That is to say, according to the contrast AF technique, before the subject's image is actually shot, the image data of multiple pictures should be collected and their contrast values should be compared to each other to find a picture with the maximum contrast value. That is why if an image to be shot were significantly affected by a camera shake, the composition of the image to be shot would change too radically to compare the contrast values of preceding and succeeding pictures to each other in the first place. As a result, it might take quite a while to get the autofocusing control done by contrast AF. On top of that, the accuracy of the contrast AF could decrease, too. For these reasons, if the zoom lens 110 falls within the range including the telephoto end, the controller 210 controls the OIS actuator 150 in MODE 1 in which the OIS lens 140 is always driven even while the through image is generated. As a result, the digital camera 100 can get the contrast AF operation done more quickly and more accurately.

On the other hand, if the zoom lens 110 falls within the range including the wide-angle end, the image being captured by the CCD image sensor 180 is much less affected by a camera shake. This is because if the zoom lens 110 falls within the range including the wide-angle end, the area to capture is wider than a situation where the zoom lens 110 falls within the range including the telephoto end. In that case, with a slight camera shake, the subject will not move significantly and the composition will hardly change. For that reason, if the zoom lens 110 falls within the range including the wide-angle end, the controller 210 controls the OIS actuator 150 in MODE 2 in which the stabilizer lens in the OIS lens 140 is driven only when required to shoot a still picture. If the controller 210 controls the OIS actuator 150 in MODE 2 in this manner, the stabilizer lens is driven only when required to shoot a still picture. That is to say, as the stabilizer lens is not driven in any other situation, the power dissipated by the OIS actuator 150 can be cut down.

1-4-2. Zooming Operation

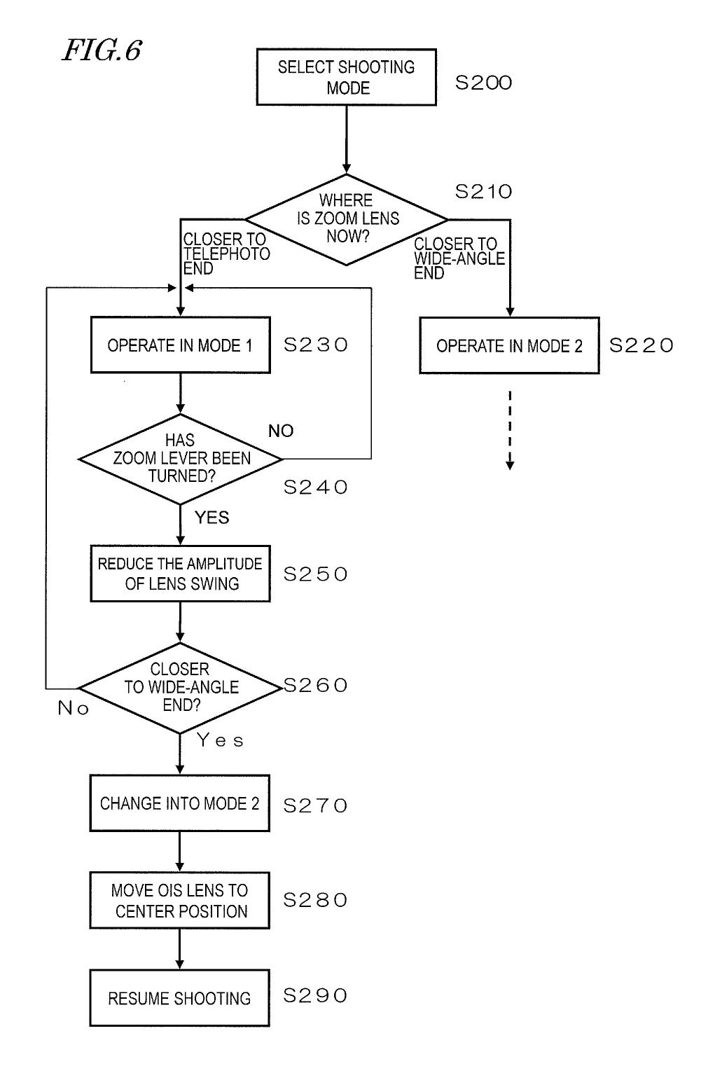

Next, it will be described with reference to FIG. 6 how to perform a control in the image stabilization mode if the user has changed zoom powers. FIG. 6 is a flowchart showing how to control the image stabilization mode in such a situation where the zoom powers have been changed.

When its mode of operation is set to be a shooting mode in Step S200, the digital camera 100 determines the location of the zoom lens 110 in Step S210. If it has been determined that the zoom lens 110 now falls within the range including the wide-angle end, then the controller 210 controls the OIS actuator 150 in MODE 2 in Step S230. On the other hand, if it has been determined that the zoom lens 110 now falls within the range including the telephoto end, then the controller 210 controls the OIS actuator 150 in MODE 1 in Step S220.

If it has determined that the OIS actuator 150 need to be controlled in MODE 1, the controller 210 sees, in Step S240, if the user has turned the zoom lever 260. If the answer is YES, the controller 210 instructs the OIS actuator 150, in Step S250, to drive the stabilizer lens within a range, which is narrower than a normal range in which the stabilizer lens in the OIS lens 140 is drivable in MODE 1.

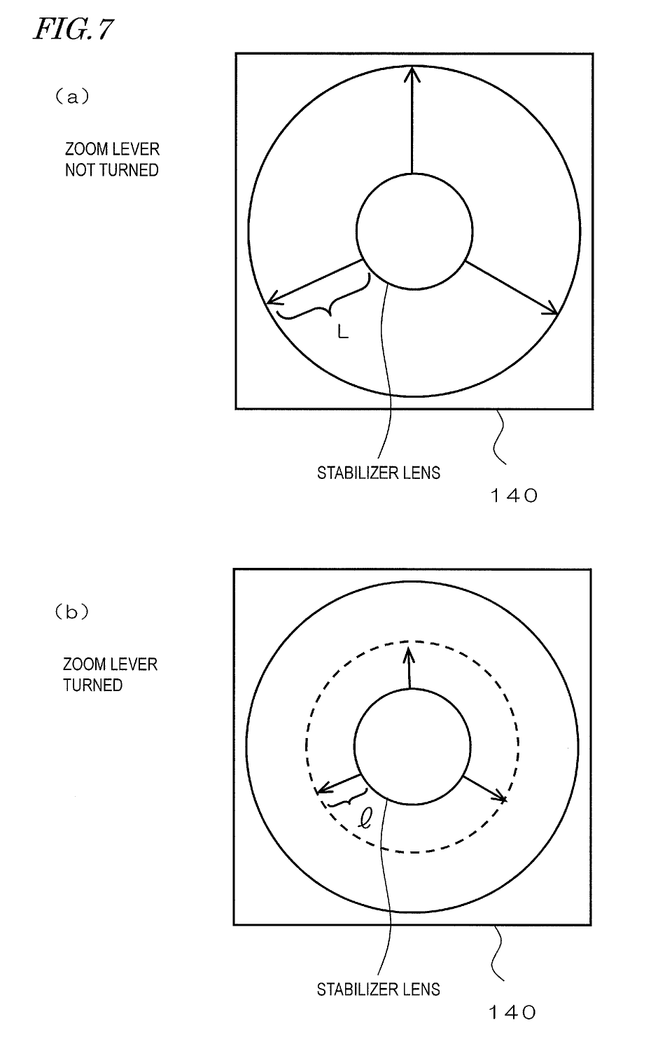

Hereinafter, it will be described with reference to FIG. 7 exactly what the “narrower range” means. As shown in FIG. 7(a), unless the zoom lever 260 is turned, the stabilizer lens in the OIS lens 140 can move at most by a length L. That is to say, the maximum range of movement is defined by L in that case. On the other hand, if the zoom lever 260 is turned, the stabilizer lens in the OIS lens 140 is driven at most by a length l (e.g., l==L/2) as shown in FIG. 7(b). In this manner, the stabilizer lens in the OIS lens 140 has its maximum range of movement changed depending on whether or not the zoom lever 260 is turned.

While the zoom lever 260 is turned, the stabilizer lens in the OIS lens 140 is driven within a range that is narrower than its maximum range of movement. This is because the user does not intend to shoot any picture, and does not care about the influence of camera shake so much, while turning the zoom lever 260. On top of that, as the user who is turning the zoom lever 260 does not intend to perform the contrast AF operation, either, there is no need to attempt to increase the accuracy of contrast AF.

If the zoom lens 110 has moved from the range including the telephoto end to the range including the wide-angle end as a result of the turn of the zoom lever 260, the modes of image stabilization are changed from MODE 1 into MODE 2. In that case, the stabilizer lens in the OIS lens 140 needs to go to its center position. If the stabilizer lens were moved a long distance in that case, however, the image would be shaken a great deal. That is why to move the stabilizer lens as short a distance as possible, the OIS actuator 150 drives the stabilizer lens in the OIS lens 140 within just a narrow range while the zoom lever 260 is being turned.

After having instructed the OIS actuator 150 to narrow the movable range of the stabilizer lens, the controller 210 determines, in Step S260, whether or not the zoom lens 110 has moved to the range including the wide-angle end. If the answer is YES, then the controller 210 changes the modes of image stabilization from MODE 1 into MODE 2 in Step S270. In that case, the controller 210 moves the stabilizer lens in the OIS lens 140 to the center of the OIS lens 140 in Step S280. This movement is needed because although the stabilizer lens in the OIS lens 140 is always moving in MODE 1 in such a direction as to cancel the camera shake produced by the user's hand or body tremors, the stabilizer lens in the OIS lens 140 needs to be fixed at the center in MODE 2 until the shutter release button 250 is pressed down fully. And when the shutter release button 250 is pressed down fully, the stabilizer lens in the OIS lens 140 starts to be driven in MODE 2 in such a direction as to cancel the camera shake produced by the user's hand or body tremors. For that reason, if the stabilizer lens in the OIS lens 140 is moved to the center of the OIS lens 140 when the modes are changed from MODE 1 into MODE 2, the digital camera 100 will be able to get the image stabilization done in MODE 2 even when the shutter release button 250 is pressed down fully after that.

After having moved the stabilizer lens to the center of the OIS lens 140, the controller 210 resumes shooting the subject's image in MODE 2 (in Step S290).

As described above, while the zoom lever 260 is being turned, the digital camera 100 of this embodiment drives the stabilizer lens in the OIS lens 140 in a narrower range than a situation where the zoom lever 260 is not turned. That is why when the stabilizer lens in the OIS lens 140 is moved to the center of the OIS lens 140 while the modes of image stabilization are changed from MODE 1 into MODE 2, the stabilizer lens needs to go a shorter distance. As a result, when the stabilizer lens moves to the center while the modes of image stabilization are changed, the shakiness of the image captured can be reduced significantly.

Furthermore, when the modes of image stabilization are changed from MODE 1 into MODE 2, the digital camera 100 of this embodiment moves the OIS lens 140 itself to the center. Thus, even if the shutter release button 250 is pressed down fully after the modes have been changed from MODE 1 into MODE 2, the stabilizer lens in the OIS lens 140 can also be readily moved from the center. As a result, image stabilization can get done more accurately in MODE 2.

Furthermore, in moving the OIS lens 140 to the center while changing the modes of image stabilization from MODE 1 into MODE 2, the digital camera 100 of this embodiment may move the OIS lens 140 either quickly or gradually and slowly. This means that the OIS lens 140 may be driven at varying velocities. For example, in a situation where the OIS lens 140 is moved to the center quickly, even if the user pressed down the shutter release button 250 fully no sooner have the modes of operation been changed into MODE 2, the image stabilization in MODE 2 can get done by moving the stabilization lens from the center of the OIS lens 140. On the other hand, if the OIS lens 140 is moved slowly to the center, the stabilizer lens will not move to the center so rapidly, and the image captured will not be violently shaken momentarily, when the modes of operation are changed into MODE 2. As a result, the user will feel a much lower degree of shakiness when the modes of operation are switched from MODE 1 into MODE 2.

As described above, the digital camera 100 of this embodiment chooses one of multiple control modes according to the zoom power specified, and controls the OIS lens 140 in the control mode chosen. The digital camera 100 has at least one control mode in which the OIS lens 140 is driven during a still picture shooting period but in which the OIS lens 140 is not driven during a non-shooting interval other than the still picture shooting period (e.g., when a through image is presented). Thus, the digital camera 100 can be switched automatically into the better image stabilization mode according to how much influence is caused by the user's hand or body tremors.

Also, the digital camera 100 of this embodiment includes the detector 120 for detecting the position of the zoom lens 110, and chooses one of the multiple control modes of the OIS lens 140 based on a result of detection obtained by the detector 120. And the digital camera 100 has at least one control mode in which the OIS lens 140 is driven when a still picture is going to be shot but in which the OIS lens 140 is not driven when a moving picture is being shot.

Thus, the digital camera 100 can shoot an image with the influence of camera shake lessened adaptively according to the position of the zoom lens 110. Also, the digital camera 100 selectively drives the stabilizer lens according to the position of the zoom lens 110 only when required to shoot a still picture. That is to say, since the stabilizer lens is not driven unless compelled by necessity, the power dissipated by the OIS actuator 150 can be cut down.

Furthermore, in a situation where the digital camera 100 of this embodiment splits the range in which the zoom lens 110 is drivable at an arbitrary point into two ranges, if the zoom lens 110 falls within one of the two ranges that includes the telephoto end, the controller 210 instructs the OIS actuator 150 to drive the OIS lens 140 for a longer time than when the zoom lens 110 falls within the other range including the wide-angle end.

As a result, even if the zoom lens 110 falls within the range including the telephoto end, the digital camera 100 can still shoot an image that is hardly affected by the camera shake. On the other hand, if the zoom lens 110 falls within the range including the wide-angle end, the digital camera 100 drives the stabilizer lens only when it is absolutely necessary to do that to shoot a still picture. That is to say, since the stabilizer lens is not driven unless compelled by necessity, the power dissipated by the OIS actuator 150 can be lower than usual.

Alternatively, in a situation where the digital camera 100 of this embodiment splits, at an arbitrary point, the range in which the zoom lens 110 is drivable into two ranges, the controller 210 may instruct the OIS actuator 150 to drive the OIS lens 140 continuously if the zoom lens 110 falls within one of the two ranges that includes the telephoto end but to drive the OIS lens 140 just temporarily during a predetermined period if the zoom lens 110 falls within the other range with the wide-angle end.

As a result, even if the zoom lens 110 falls within the range including the telephoto end, the digital camera 100 can still shoot an image that is hardly affected by the camera shake. Otherwise, the digital camera 100 drives the stabilizer lens only when it is absolutely necessary to do that to shoot a still picture. That is to say, since the stabilizer lens is not driven unless compelled by necessity, the power dissipated by the OIS actuator 150 can be lower than usual.

Furthermore, in the digital camera 100 of this embodiment, the OIS lens 140 is a stabilizer lens that can move within a plane that intersects with the optical axis at right angles in order to stabilize the subject's image captured by the CCD image sensor 180. In a situation where the range in which the zoom lens 110 is drivable is split at an arbitrary point into two ranges, when the zoom lens 110 moves from one of the two ranges that includes the telephoto end into the other range including the wide-angle end, the controller 210 may instruct that the stabilizer lens be moved to center of the plane in which it can be driven.

Then, even if the shutter release button 250 is pressed down fully when the modes of operation are switched from MODE 1 into MODE 2, the stabilizer lens in the OIS lens 140 can be moved from the center. As a result, image stabilization can get done more accurately in MODE 2.

The digital camera 100 of this embodiment further includes a zoom lever 260 that accepts a zooming instruction given by the user. When the zoom lever 260 is accepting the zooming instruction given by the user, the zoom motor 130 drives the zoom lens 110 and the OIS actuator 150 narrows the range in which the OIS lens 140 is driven.

In that case, when the stabilizer lens in the OIS lens 140 is moved to the center of the OIS lens 140 while the modes of image stabilization are switched from MODE 1 into MODE 2, the stabilizer lens needs to go a shorter distance. As a result, the amplitude of the image being captured that is shaken by the move of the stabilizer lens to the center when the modes of image stabilization are switched can be reduced.

### 2. Embodiment 2

A second embodiment of the present invention, which is also implemented as a digital still camera (which will be simply referred to herein as a “digital camera”), will be described with reference to the accompanying drawings. In the following description, any component of the digital camera of this embodiment, having substantially the same function as its counterpart 100 of the first embodiment described above, will be identified by the same reference numeral, and the description thereof will be omitted herein to avoid redundancies. It should be noted that the digital camera of this second embodiment will also be identified by the same reference numeral 100.

### 2-1. Electrical Configuration

Unlike the digital camera of the first embodiment described above, the digital camera of this embodiment has no zoom lens 110, detector 120 or zoom motor 130. Instead, in the digital camera 100 of this embodiment, the image processing section 190 can perform so-called “electronic zooming” (which means digital zooming). Specifically, the image processing section 190 carries out zoom-in or zoom-out processing electronically on the image data that has been generated by the CCD image sensor 180. For that purpose, the image processing section 190 performs image data cropping processing, thinning out processing or interpolation processing, if appropriate, on the image data that has been generated by the CCD image sensor 180. In short, the image processing section 190 can convert the resolution of the image data.

### 2-2. Exemplary Operation

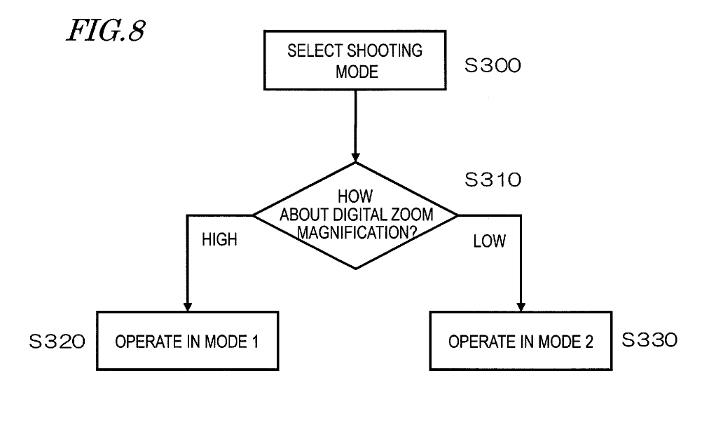

Hereinafter, it will be described with reference to FIG. 8 by way of example how the digital camera 100 of this embodiment may operate.

FIG. 8 is a flowchart showing an exemplary procedure of operation of this digital camera 100.

First of all, when the digital camera 100 has its mode of operation set by the user to be shooting in Step S300, the controller 210 determines in Step S310 a digital zoom magnification for the image data that has been generated by the image processing section 190. More specifically, the controller 210 determines whether or not the image data that has been generated by the CCD image sensor 180 has been subjected to electronic zooming by the image processing section 190. If the answer is YES, the controller 120 determines in Step S310 whether or not its digital zoom magnification is greater than a predetermined threshold value. In this case, the “predetermined threshold value” may be any arbitrary value. If the answer is YES, the controller 210 instructs the OIS actuator 150 to drive the lens in MODE 1 in Step S320.

Otherwise (i.e., if the controller 210 has determined the digital zoom magnification of the image data that has been generated by the image processing section 190 to be equal to or smaller than the predetermined threshold value), the controller 210 instructs the OIS actuator 150 to drive the lens in MODE 2 (in Step S330).

For example, suppose the threshold value of the zoom power is set to be 2× for a digital camera with a wide-angle focal length of 25 mm. In that case, the control mode remains MODE 2 until the zoom power exceeds 2×. But once the zoom power exceeds 2× (which means the focal length increases to 50 mm), the control modes are switched from MODE 2 into MODE 1. It should be noted that the focal length is proportional to the zoom power.

Next, it will be described why such a control is carried out. Specifically, if the digital zoom magnification is higher than the predetermined threshold value, the captured image being generated by the image processing section 190 is easily subject to camera shake. This is because if the digital zoom magnification is higher than the predetermined threshold value, the subject to shoot will be narrower than a situation where the digital zoom magnification is lower than the predetermined threshold value. In that case, even with a slight camera shake, the subject will move significantly and the composition will change totally. For that reason, if the digital zoom magnification is higher than the predetermined threshold value, the controller 210 controls the OIS actuator 150 in MODE 1 in which the OIS lens 140 is always driven even while the through image is generated. As a result, even if the digital zoom magnification is higher than the predetermined zoom power, the digital camera 100 can also shoot an image that is hardly affected by the camera shake.

Also, for the same reason as what has already been described for the first embodiment, if such a control is carried out when contrast AF (which is also called “hill-climbing AF”) is selected as a mode of autofocusing (AF), the contrast AF can get done more quickly and more accurately. That is why if the digital zoom magnification is higher than the predetermined threshold value, the controller 210 controls the OIS actuator 150 in MODE 1 in which the OIS lens 140 is always driven even when the through image is generated. As a result, the digital camera 100 can get the contrast AF done relatively quickly.

In performing electronic zooming, if contrast AF is carried out on the image data that has not been cropped yet, the contrast AF can get done relatively quickly. In that case, however, the size of an AF frame, representing an in-focus position, will change significantly according to the digital zoom magnification. Specifically, the AF frame is set for pixels falling within a certain range of the CCD image sensor 180 and uses the values of those pixels. An AF frame that has been set on the image data yet to be cropped will increase its size as a portion of the image is cropped and magnified. For that reason, the size of the AF frame representing the in-focus position will change according to the digital zoom magnification. However, this is not beneficial in a situation where electronic zooming is adopted as an extension to optical zooming. That is why if contrast AF is carried out only on the cropped portion of the image data captured, the contrast AF can get done relatively quickly by adopting the control method of the digital camera 100 of this embodiment.

On the other hand, if the digital zoom magnification is smaller than the predetermined threshold value, the image being captured by the CCD image sensor 180 is much less affected by a camera shake. This is because if the digital zoom magnification is smaller than the predetermined threshold value, the area to capture is wider than a situation where the digital zoom magnification is greater than the predetermined threshold value. In that case, with a slight camera shake, the subject will not move significantly and the composition will hardly change. For that reason, if the digital zoom magnification is smaller than the predetermined threshold value, the controller 210 controls the OIS actuator 150 in MODE 2 in which the stabilizer lens in the OIS lens 140 is driven only when required to shoot a still picture. If the controller 210 controls the OIS actuator 150 in MODE 2 in this manner, the stabilizer lens is driven only when required to shoot a still picture. That is to say, as the stabilizer lens is not driven in any other situation, the power dissipated by the OIS actuator 150 can be cut down.

As described above, the digital camera 100 of this embodiment chooses one of multiple control modes for the OIS lens 140 according to the zoom power that has been used to crop and magnify a portion of the image data that has been generated by the CCD image sensor 180. One of the control modes is defined so that the OIS lens 140 is driven during a still picture shooting period but not driven during a non-shooting interval other than the still picture shooting period (e.g., when a through image is presented).

As a result, even if the digital zoom magnification is greater than the predetermined threshold value, the digital camera 100 can still shoot an image that is hardly affected by the camera shake. Also, the digital camera 100 drives the stabilizer lens only when it is absolutely necessary to do that to shoot a still picture. That is to say, since the digital camera 100 does not drive the stabilizer lens unless compelled by necessity, the power dissipated by the OIS actuator 150 can be lower than usual.

Although first and second illustrative embodiments of the present invention have been described, the present invention is in no way limited to those embodiments but can be readily modified in various other ways. Hereinafter, some of those modifications to the first and second embodiments of the present invention will be described.

In the first embodiment of the present invention described above, when the zoom lens 100 moves from the range including the telephoto end to the range including the wide-angle end, the stabilizer lens in the OIS lens 140 is supposed to be moved to the center. However, the stabilizer lens may also be fixed at a certain position in the OIS lens 140 when the zoom lens 100 moves from the range including the telephoto end to the range including the wide-angle end.

Also, in the first embodiment described above, if a zooming instruction by the user is accepted when the zoom lens 110 falls within the range including the telephoto end, the distance to go for the stabilizer lens in MODE 1 is supposed to be always limited. However, the present invention is in no way limited to that embodiment. Alternatively, only when the zoom lens 110 falls within the range including the telephoto end and in the vicinity of an arbitrary point where the modes of operation are switched from MODE 1 into MODE 2, or vice versa, the distance to go for the stabilizer lens could be limited as well.

The digital camera of the first embodiment described above is supposed to be able to perform optical zooming only, while the camera of the second embodiment described above is supposed to be able to perform electronic zooming only. However, the present invention is also applicable to an image capture device that can perform both optical zooming and electronic zooming alike. In that case, the focal length of the zoom lens 110 may be converted, based on the size of the CCD image sensor 180, into a focal length for a 35 mm photographic film. And by determining whether or not the product of the 35 mm converted focal length and the digital zoom magnification exceeds a predetermined threshold value, either MODE 1 or MODE 2 may be adopted selectively.

Furthermore, the digital camera may also be modified to change into electronic zooming if a greater zoom power is still needed even after the zoom lens 110 has reached its telephoto focal length as a result of optical zooming. In that case, while the optical zooming is still ON, the image stabilization control modes may be changed according to the threshold value from MODE 2 into MODE 1. And once the electronic zooming has been turned ON, the control may always be performed in MODE 1. Then, the correlation between the zooming control and the image stabilization control can be simplified, and therefore, the controller 210 may control the detector 120, the image processing section 190 and the OIS actuator 150 more simply. Still alternatively, the digital camera may always operate in MODE 2 while the optical zooming is ON but may change into MODE 1 when the digital zoom magnification reaches a threshold value after the modes of zooming have been switched from the optical one into the electronic one. In any case, the control modes are changed according to either the zoom power or the focal length.

Furthermore, in the first embodiment described above, the range in which the zoom lens 110 is drivable is supposed to be split into two ranges in which the OIS lens 140 is controlled by mutually different methods. However, the present invention is in no way limited to that embodiment. Alternatively, the range in which the zoom lens 110 is drivable may be divided into three or four ranges and the OIS lens 140 may be controlled by mutually different methods. The range could be divided evenly, for example. Anyway, it is just necessary to divide the range in which the zoom lens 110 is drivable into multiple ranges and adjust the method of controlling the OIS lens 140 from one range to another.

The optical system and drive system of the digital camera 100 shown in FIG. 1 are just an example and do not always have to be used. For example, in the embodiment illustrated in FIG. 1, the optical system is supposed to consist of three groups of lenses. However, the optical system may also consist of any other groups of lenses. Also, although the zoom lens 110 forms part of the optical system in the example illustrated in FIG. 1, neither the OIS lens 140 nor the OIS actuator 150 is an essential element. Optionally, image stabilization can also get done by providing an actuator that drives the CCD image sensor 180 in such a direction as to cancel the camera shake produced by the user's hand or body tremors. Furthermore, although each of the lenses 110 and 170 that form the optical system is illustrated as a single lens in the drawings, each of the lenses 110 and 170 may also be a group of multiple lenses.

Also, in the first and second embodiments of the present invention described above, the imager is supposed to be the CDD image sensor 180. However, the present invention is in no way limited to those embodiments. Alternatively, the imager may also be a CMOS image sensor or an NMOS image sensor.

The image processing section 190 and the controller 210 may be implemented as either a single semiconductor chip or two different semiconductor chips.

For example, if the controller 210 is implemented as a microcomputer, the processing that has been described above with reference to the flowcharts of the accompanying drawings could be implemented as a program to be executed by the microcomputer. Such a computer program may be circulated on the market by being stored on a storage medium such as a CD-ROM or downloaded over telecommunications lines such as the Internet.

The embodiments described above are just an example of the present invention, which can also be defined as follows:

(1) An image capture device comprising:
an optical system for producing a subject's image;
an imager for capturing the subject's image;
a sensor for sensing a shake of the device itself;
a driving section, which is provided for either the optical system or the imager to drive the optical system or the imager; and
a control section for generating an instruction value to drive the driving section based on the device's own shake that has been sensed,
wherein the optical system includes a zoom lens for changing the zoom powers of the subject's image by moving along an optical axis, and
wherein the control section chooses one of multiple control modes according to a zoom power or a focal length, which is determined by the position of the zoom lens, and generates the instruction value according to the control mode chosen, and
wherein the multiple control modes include a mode in which the control section generates an instruction value to reduce the blur of the subject's image, which has been caused due to the device's own shake, during a still picture shooting period and not to reduce the blur of the subject's image during a non-shooting interval other than the still picture shooting period.

(2) The image capture device of (1), further comprising:
a lens driving section for driving the zoom lens; and
a detector for detecting the position of the zoom lens,
wherein the control section determines the zoom power or the focal length by the position of the zoom lens that has been detected.

(3) The image capture device of (2), wherein the imager captures the subject's image by performing an exposure process, and
wherein the control section generates the instruction value to stabilize the subject's image during the still picture shooting period, which begins when preparation for the exposure process is started and which ends when the exposure process is completed.

(4) The image capture device of (3), wherein the multiple control modes include:
a first control mode in which the control section generates the instruction value to stabilize the subject's image during the still picture shooting period and to generate the instruction value to stabilize the subject's image during the non-shooting interval; and
a second control mode in which the control section generates the instruction value to stabilize the subject's image continuously, no matter whether it is the still picture shooting period or not, and
wherein if a range in which the zoom lens is drivable is split into a range including a telephoto end and a range including a wide-angle end,
then the control section chooses the first control mode when the zoom lens falls within the range including the wide-angle end but chooses the second control mode when the zoom lens falls within the range including the telephoto end.

(5) The image capture device of (3), wherein if a range in which the zoom lens is drivable is split into a range including a telephoto end and a range including a wide-angle end,
the control section generates an instruction value to stabilize the subject's image in varying time lengths depending on whether the zoom lens falls within the range including the wide-angle end or the range including the telephoto end.

(6) The image capture device of (5), wherein if the zoom lens falls within the range including the telephoto end, the control section generates the instruction value to stabilize the subject's image for a longer time than a situation where the zoom lens falls within the range including the wide-angle end.

(7) The image capture device of (6), wherein if the zoom lens falls within the range including the telephoto end, the control section generates the instruction value to stabilize the subject's image continuously, no matter whether it is the still picture shooting period or not.

(8) The image capture device of (2), wherein the optical system includes a stabilizer lens that is movable within a plane that intersects with the optical axis at right angles, and
wherein the driving section drives the stabilizer lens of the optical system within the plane in accordance with the instruction value, and
wherein if a range in which the zoom lens is drivable is split into a range including a telephoto end and a range including a wide-angle end,
the control section generates an instruction value to move the stabilizer lens to a predetermined reference position within the plane once the zoom lens has moved from the range including the telephoto end to the range including the wide-angle end.

(9) The image capture device of (8), wherein the control section generates an instruction value to move the stabilizer lens to the center of the plane as the reference position.

(10) The image capture device of (8), further comprising an interface section that allows the user to change the zoom powers,
wherein the lens driving section drives the zoom lens adaptively to the zoom power that has been specified with the interface section, and
wherein the control section generates an instruction value to limit the range in which the stabilizer lens is movable while the zoom lens is being driven.

(11) The image capture device of (10), wherein the control section generates an instruction value to move the stabilizer lens within a range that is narrower than the maximum range in which the stabilizer lens is movable.

(12) The image capture device of (2), further comprising:
an interface section that allows the user to change the zoom powers; and
an image processing section for magnifying a portion of image data, which has been generated based on the output of the imager so as to represent the subject's image, according to the zoom power,
wherein the control section determines the zoom power or the focal length according to the zoom power that has been specified with the interface section.

(13) An image capture device comprising:
an optical system for producing a subject's image;
an imager for capturing the subject's image;
a sensor for sensing a shake of the device itself;
an image processing section for magnifying a portion of image data, which has been generated based on the output of the imager so as to represent the subject's image, according to the zoom power;
a driving section, which is provided for either the optical system or the imager to drive the optical system or the imager; and
a control section for generating an instruction value to drive the driving section based on the device's own shake that has been sensed,
wherein the control section chooses one of multiple control modes according to the zoom power or a focal length, which is determined by the zoom power, and generates the instruction value according to the control mode chosen, and
wherein the multiple control modes include a mode in which the control section generates an instruction value to reduce the blur of the subject's image, which has been caused due to the device's own shake, during a still picture shooting period and does not generate an instruction value to reduce the blur of the subject's image during a non-shooting interval other than the still picture shooting period.

### INDUSTRIAL APPLICABILITY

The present invention is applicable to digital still cameras and digital movie cameras to name just a few.

### REFERENCE SIGNS LIST

100 digital camera
110 zoom lens
120 detector
130 zoom motor
140 OIS
150 OIS actuator
160 detector
170 focus lens
180 CCD image sensor
190 image processing section
200 memory
210 controller
220 gyrosensor
230 card slot
240 memory card
250 shutter release button
260 zoom lever
270 LCD monitor

1. An image capture device with the ability to change zoom powers, the device comprising:
an optical system for producing a subject's image;
an imager for capturing the subject's image that has been produced by the optical system;
a compensation section for stabilizing the subject's image on the imager; and
a control section for choosing one of multiple control modes according to the zoom power and controlling the compensation section in the control mode chosen,
wherein at least one of the multiple control modes is defined so that the control section instructs the compensation section to stabilize the subject's image during a still picture shooting period and not to stabilize the subject's image during a non-shooting interval other than the still picture shooting period.

2. The image capture device of claim 1, further comprising:
a zoom lens for changing the zoom powers by moving along an optical axis;
a lens driving section for driving the zoom lens; and
a detecting section for detecting the position of the zoom lens,
wherein the control section chooses one of the multiple control modes based on a result of detection obtained by the detecting section.

3. The image capture device of claim 2, wherein the multiple control modes include:
a first control mode in which the control section instructs the compensation section to stabilize the subject's image continuously, no matter whether it is the still picture shooting period or not; and
a second control mode in which the control section instructs the compensation section to stabilize the subject's image during the still picture shooting period but not to stabilize the subject's image during the non-shooting interval, and
wherein if a range in which the zoom lens is drivable is split into a range including a telephoto end and a range including a wide-angle end,
then the control section chooses the second control mode when the zoom lens falls within the range including the wide-angle end and chooses the first control mode when the zoom lens falls within the range including the telephoto end.

4. The image capture device of claim 3, wherein the optical system includes a stabilizer lens that is movable within a plane that intersects with the optical axis at right angles, and
wherein by driving the stabilizer lens of the optical system within the plane, the compensation section stabilizes the subject's image on the imager, and
wherein the control section instructs the compensation section to move the stabilizer lens to a predetermined reference position within the plane once the zoom lens has moved from the range including the telephoto end to the range including the wide-angle end.

5. The image capture device of claim 4, wherein the control section instructs the compensation section to move the stabilizer lens to the center of the plane as the reference position.

6. The image capture device of claim 5, further comprising an interface section that allows the user to change the zoom powers,
wherein the lens driving section drives the zoom lens adaptively to the zoom power that has been specified with the interface section, and
wherein the control section instructs the compensation section to limit the range in which the stabilizer lens is movable while the zoom lens is being driven.

7. The image capture device of claim 1, further comprising:
an interface section that allows the user to change the zoom powers; and
an image processing section for magnifying a portion of image data, which has been generated based on the output of the imager so as to represent the subject's image, according to the zoom power that has been specified with the interface section,
wherein the control section chooses one of the multiple control modes according to the zoom power that has been specified with the interface section.
